(19) United States
(12) Patent Application Publication
(10) Pub. No.: US 2026/0237773 A1
(43) Pub. Date: Aug. 13, 2026

(54) METHOD OF PREPARING TERNARY CATHODE MATERIAL FROM RECYCLED WASTE LITHIUM-ION BATTERIES

(71) Applicant: National Tsing Hua University, Hsinchu City (TW)

(72) Inventors: Chih-Huang LAI, Hsinchu City (TW); Jing-Yin LIN, Hsinchu City (TW); Tzu-Min CHENG, Tainan City (TW); Zheng-Yu CHEN, Hsinchu City (TW); Yung-Fa YANG, Kaohsiung City (TW); Tsung-Tien CHEN, Kaohsiung City (TW)

(21) Appl. No.: 19/288,369

(22) Filed: Aug. 1, 2025

(30) Foreign Application Priority Data
Feb. 7, 2025 (TW) 114104608

(51) Int. Cl. H01M 10/54; C22B 7/00; C22B 26/12; H01M 4/02; H01M 4/04; H01M 4/38; H01M 10/0525

(52) U.S. Cl. CPC H01M 10/54; C22B 7/007; C22B 26/12; H01M 4/0471; H01M 4/38; H01M 10/0525; H01M 2004/028

(57) ABSTRACT

A method of preparing a ternary cathode material includes: mixing a cathode material of waste lithium-ion batteries with an acid leachate to obtain a leachate solution including metal ions; adding a first pH adjusting agent into the leachate solution so that a first metal precipitate is formed and separated from the leachate solution to obtain a first filtrate; adding a second pH adjusting agent into the first filtrate so that a second metal precipitate is formed and separated from the first filtrate to obtain a second filtrate; adding a concentration-adjusting agent into the second filtrate to adjust a ratio of nickel ions, cobalt ions, and manganese ions and to obtain a mother liquid including the nickel ions, the cobalt ions, and the manganese ions with a target ratio; and adding a co-precipitant into the mother liquid to obtain a precursor of a nickel-cobalt-manganese-containing ternary cathode material.

### CROSS-REFERENCE TO RELATED APPLICATION

This application claims priority to Taiwanese Invention Patent Application No. 114104608, filed on Feb. 7, 2025, the entire disclosure of which is incorporated by reference herein.

### FIELD

The disclosure relates to a method of recycling and reusing cathodes of waste lithium-ion batteries, and more particularly to a method of preparing a ternary cathode material from recycled waste lithium-ion batteries.

### BACKGROUND

Compared to conventional nickel metal hydride batteries, lithium-ion batteries exhibit outstanding characteristics (e.g., high energy densities, high working voltages, wide operating temperature ranges, long operating lifetime, etc.). Thus, they have been widely used as batteries in electric vehicles. With continuous development in the electric vehicle industry, it is expected that there will be a large number of waste lithium-ion batteries that will need to be replaced with new lithium-ion batteries in three to five years. If the waste lithium-ion batteries are not properly recycled and processed, there may be safety issues or environmental protection problems (e.g., a short circuit, spontaneous combustion or generation of hazardous gases while storing or delivering the waste lithium-ion batteries). Therefore, there is a need to develop a safe and environmentally friendly method for recycling the waste lithium-ion batteries.

The waste lithium-ion batteries, based on ingredients of cathode materials thereof, can be divided into five categories: lithium cobalt oxide (LCO) batteries; lithium manganese oxide (LMO) batteries; lithium nickel cobalt manganese oxide (NCM) batteries; lithium nickel cobalt aluminum oxide (NCA) batteries; and lithium iron phosphate (LFP) batteries. Existing technologies for recycling cathodes of the lithium-ion batteries, such as a well-established pyrometallurgy method or a commercialized thermal decomposition spray pyrolysis (TDSP) (for example, a regeneration method disclosed in US 2023/0357050 A1), are each a method for recycling cathodes of waste lithium-ion batteries of a single type. Thus, to recycle and reuse the cathodes of the waste lithium-ion batteries of various types, a complicated sorting process, which is inconvenient and time-consuming, is required. Therefore, development of a recycling method that can process all types of cathodes of the waste lithium-ion batteries at the same time is required.

US 2023/0357050 A1, which is also referred to as a first document hereinafter, discloses a method for recycling a waste ternary cathode material of lithium-ion batteries. It can be employed to process the waste lithium-ion batteries described above. The waste lithium-ion batteries may be subjected to a leach process with an acid to obtain a solution including metal ions. The solution is then filtered and subjected to various precipitation processes to sequentially recycle precipitates of iron phosphate, aluminum hydroxide, manganese oxide, cobalt oxide, nickel hydroxide, lithium carbonate, etc. However, the first document does not further disclose any detail about subsequent applications for each of the recycled precipitates. Recycling efficiency for each of the metal ions of the method is also not revealed in the first document. In addition, preparation of a ternary cathode material is also not disclosed in the first document.

A method for recycling and preparing a precursor of a ternary cathode and a ternary cathode material using sodium carbonate as a co-precipitant is disclosed in an academic journal by L.-Po He et al., “Performance of LiNi_{1/3}Co_{1/3}Mn_{1/3}O₂ prepared from spent lithium-ion batteries by a carbonate co-precipitation method,” Ceramics International (2018), vol. 44, pages 351-357. Characteristics and electrochemical performance of each of the precursor of the ternary cathode and the ternary cathode material are also evaluated in the academic journal. However, in the method, waste cathode materials are subjected to a leaching process. Then, a ratio of nickel ions, cobalt ions and manganese ions in an acid leachate is directly adjusted, followed by directly performing a co-precipitation process. Since the method lacks a process that removes impurities, the precursor of the ternary cathode obtained thereby may exhibit undesired purity. Thus, purity of the ternary cathode material obtained from the precursor of the ternary cathode may also be questionable. As such, lithium-ion batteries manufactured therefrom also exhibit undesired initial electrochemical performance.

### SUMMARY

Therefore, an object of the disclosure is to provide a method of preparing a ternary cathode material from waste lithium-ion batteries that can alleviate at least one of the drawbacks of the prior art.

According to the disclosure, a method of preparing a ternary cathode material from waste lithium-ion batteries includes the steps of:
a) mixing a cathode material of the waste lithium-ion batteries with an acid leachate such that metal ions are leached from the cathode material so as to obtain a leachate solution including the metal ions;
b) adding a first pH adjusting agent into the leachate solution such that a pH value of the leachate solution is increased to a first target pH value, and a first metal precipitate is formed and separated from the leachate solution so as to obtain a first filtrate;
c) adding a second pH adjusting agent into the first filtrate such that a pH value of the first filtrate is increased to a second target pH value which is greater than the first target pH value, and a second metal precipitate is formed and separated from the first filtrate so as to obtain a second filtrate;
d) adding a concentration-adjusting agent into the second filtrate to adjust a ratio of nickel ions, cobalt ions, and manganese ions in the second filtrate to a target ratio so as to obtain a mother liquid including the nickel ions, the cobalt ions, and the manganese ions with the target ratio; and
e) adding a co-precipitant into the mother liquid until a pH value of the mother liquid is increased to a third target pH value which is greater than the second target pH value, such that the nickel ions, the cobalt ions, and the manganese ion in the mother liquid are co-precipitated, so as to obtain a precursor of a nickel-cobalt-manganese-containing ternary cathode material.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 shows a solubility prediction diagram illustrating graph plots of concentrations of various metal ions versus pH values.

FIG. 2A is a perspective view illustrating an automatic machine that can be used to perform a method of the present disclosure.

FIG. 2B is a schematic view illustrating communication channels in the automatic machine.

FIG. 2C is a perspective view illustrating a filtration box and a filtration bag in the automatic machine.

FIG. 3 shows scanning electron microscope (SEM) images illustrating microstructures of a ternary cathode material obtained from an embodiment of the present disclosure at various magnifications.

FIG. 4A is an X-ray diffraction spectrum (i.e., an XRD spectrum) illustrating a crystal structure of the ternary cathode material.

FIG. 4B is an XRD spectrum illustrating crystal structures of two commercialized nickel-cobalt-manganese ternary cathode materials.

FIG. 5A is an X-ray photoelectron spectroscopy (XPS) spectrum (i.e., an XPS spectrum) illustrating an oxidation state of nickel in the ternary cathode material.

FIG. 5B is an XPS spectrum illustrating an oxidation state of cobalt in the ternary cathode material.

FIG. 5C is an XPS spectrum illustrating an oxidation state of manganese in the ternary cathode material.

FIG. 6A is a charging-discharging chart illustrating electrochemical characteristics of a lithium-ion battery made of the ternary cathode material.

FIG. 6B is a cyclic stability chart illustrating cyclic stability of the lithium-ion battery.

### DETAILED DESCRIPTION

Before the disclosure is described in greater detail, it should be noted that where considered appropriate, reference numerals or terminal portions of reference numerals have been repeated among the FIG.s to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

The following descriptions provide details of various specific embodiments of a method of the present disclosure.

An embodiment of a method of preparing a ternary cathode material from waste lithium-ion batteries includes the steps of:
a) mixing a cathode material of the waste lithium-ion batteries with an acid leachate such that metal ions are leached from the cathode material so as to obtain a leachate solution including the metal ions;
b) adding a first pH adjusting agent into the leachate solution such that a pH value of the leachate solution is increased to a first target pH value, and a first metal precipitate is formed and separated from the leachate solution so as to obtain a first filtrate;
c) adding a second pH adjusting agent into the first filtrate such that a pH value of the first filtrate is increased to a second target pH value which is greater than the first target pH value, and a second metal precipitate is formed and separated from the first filtrate so as to obtain a second filtrate;
d) adding a concentration-adjusting agent into the second filtrate to adjust a ratio of nickel ions, cobalt ions, and manganese ions in the second filtrate to a target ratio so as to obtain a mother liquid including the nickel ions, the cobalt ions, and the manganese ions with the target ratio; and
e) adding a co-precipitant into the mother liquid until a pH value of the mother liquid is increased to a third target pH value which is greater than the second target pH value, such that the nickel ions, the cobalt ions, and the manganese ion in the mother liquid are co-precipitated, so as to obtain a precursor of a nickel-cobalt-manganese-containing ternary cathode material.

In some embodiments, the method of the present disclosure further includes, prior to step a), providing a cathode material of the waste lithium-ion batteries that are recycled.

In the description above, the method of the present disclosure is suitable for recycling and reusing a cathode material in each of all types of the waste lithium-ion batteries. That is, the cathode material in each of all types of the waste lithium-ion batteries may be processed at the same time. Thus, in step a), the cathode material of the waste lithium-ion batteries includes a cathode material of waste lithium cobalt oxide batteries, a cathode material of waste lithium manganese oxide batteries, a cathode material of waste lithium nickel cobalt manganese oxide batteries, a cathode material of waste lithium nickel cobalt aluminum oxide batteries, a cathode material of waste lithium iron phosphate batteries, or combinations thereof.

In some embodiments, the cathode material of the waste lithium-ion batteries is a black powdery material. The black powdery material of the cathode material of the waste lithium-ion batteries may be obtained by subjecting one or more of the aforesaid cathode materials of the waste lithium-ion batteries to a pretreatment process.

The pretreatment process aims to separate the cathode material (i.e., an active material) from components of batteries (e.g., outer shells, separation membranes, current collectors, electrolytes, active substances, and binders). The pretreatment process may be a laboratory scale pretreatment process or a large scale (e.g., an industrial scale) pretreatment process. A high-quality cathode material (i.e., the active material) can be obtained by the laboratory scale pretreatment process with great separation efficiency, and can be subjected to an acid leaching process or a subsequent metal recycling process. For the large scale pretreatment process, in order to achieve separation efficiency for the cathode material (i.e., the active material) as great as the laboratory scale pretreatment process, one or more additional processes are usually required. Details of the aforesaid pretreatment processes are illustrated in the following description.

The laboratory scale pretreatment process suitable for the method of the present disclosure includes soaking the waste lithium-ion batteries in a saturated sodium chloride solution for about 0.5 hours (hrs) to about 24 hrs so that the waste lithium-ion batteries may be completely discharged. Then, the waste lithium-ion batteries, which have been completely discharged, are dried by baking. The outer shells of the waste lithium-ion batteries are dissembled manually, and the cathodes, anodes, and the separation membranes are sorted so as to obtain the cathodes. Thereafter, the cathodes are subjected to a calcination process at an elevated temperature ranging from about 350° C. to about 600° C., such that binders, and electrolytes are decomposed, thereby obtaining the cathode material (i.e., the active material) in a powdery form.

The large scale pretreatment process suitable for the method of the present disclosure includes mechanically crushing the waste lithium-ion batteries, followed by a sieving process. The waste lithium-ion batteries are mechanically crushed at a low temperature or in an inert atmosphere to avoid explosion, ignition or generation of toxic gases. Prior to mechanically crushing the waste lithium-ion batteries, a saturated sodium chloride solution may also be used to discharge make the waste lithium-ion batteries be discharged, which is similar to the laboratory scale pretreatment process. In the sieving process, a portion of the cathode material (the active material) may be mixed with metals (e.g., aluminum, copper, iron, etc.) so that they may be sieved. There is an inherent trade-off between yield and purity when choosing a mesh size of a sieve. A remaining portion of the cathode material (the active material) may include impurities (e.g., carbon blacks), and thus the calcination process is required to remove the impurities so as to obtain the cathode material (the active material) with relatively high purity, thereby facilitating the subsequent metal recycling process.

In some embodiments, the cathode material of the waste lithium-ion batteries in the method of the present disclosure is obtained from cathodes of waste lithium nickel cobalt manganese oxide batteries, which is provided by Chung Tai Resource Technology™ Corp., a subsidiary of Cleanaway Company LTD. A pretreatment process for the cathode material of the waste lithium-ion batteries includes a step for discharging the waste lithium-ion batteries, a step for separating the cathodes from current collectors, a step for removing binders, and a step for crushing the waste lithium-ion batteries, etc. However, in actual practice, outer shells and the current collectors of the waste lithium-ion batteries are not completely separated from each other. Thus, a composition of the cathode material of the waste lithium-ion batteries may be similar to a composition of a cathode material of the waste lithium-ion batteries that are obtained from processing the cathodes of the all types of the waste lithium-ion batteries on the market at the same time.

In some embodiments, the method of the present disclosure further includes, prior to providing the cathode material of the waste lithium-ion batteries, an impurity detection step, which involves detecting an impurity level of the cathode material of the waste lithium-ion batteries by an induced couple plasma-optical emission spectrometer (ICP-OES).

In some embodiments, step a) is performed by mixing the cathode material of the waste lithium-ion batteries with the acid leachate such that the metal ions are leached from the cathode material so as to obtain the leachate solution including the metal ions.

In some embodiments, the acid leachate includes an acid. The acid includes hydrochloric acid, nitric acid, sulfuric acid, phosphoric acid, acetic acid, citric acid, L-tartaric acid, or combinations thereof. Based on an acid leaching performance, the acid may be acetic acid, citric acid, L-tartaric acid, or combinations thereof. In some embodiments, the acid may be nitric acid, sulfuric acid, phosphoric acid, or combinations thereof. In certain embodiments, the acid is hydrochloric acid. It should be noted that when hydrochloric acid is used to serve as the acid leachate, a toxic gas (e.g., chlorine gas) may be produced during an acid leaching process. Thus, precautions should be taken to prevent personal safety and environmental safety issues. In certain embodiments, in step a), the acid is sulfuric acid and has a concentration ranging from 2 M to 18 M.

In some embodiments, the acid leachate includes a mixture of the acid and a reducing agent. The reducing agent may include hydrogen peroxide, sodium thiosulfate, sodium bisulfate, glucose, citric acid, or combinations thereof. In certain embodiments, in step a), the reducing agent is hydrogen peroxide that has a concentration ranging from 2 wt % to 10 wt %.

In some embodiments, step a) is performed at a leaching temperature ranging from a room temperature (e.g., 25° C.) to 80° C. In certain embodiments, the leaching temperature ranges from 65° C. to 80° C. It should be noted that when the leaching temperature is higher than 80° C., the acid leachate may boil, which may result in a safety issue. In some embodiments, step a) is performed for a leaching time period ranging from 0.5 hrs to 3 hrs. In certain embodiments, the leaching time period ranges from 1 hr to 2 hrs.

In some embodiments, when the acid leaching process in step a) is accomplished, the leachate solution includes iron ions, phosphorus ions, aluminum ions, copper ions, zinc ions, nickel ions, cobalt ions, manganese ions, lithium ions, or combinations thereof.

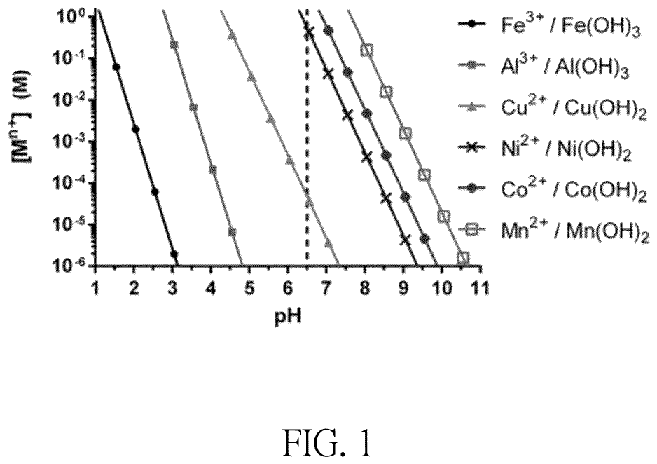

It should be particularly pointed out that in order to avoid problems in the prior art, inventors of the present disclosure thus made great efforts to consult academic literatures and found T. Or et al., “Recycling of mixed cathode lithium-ion batteries for electric vehicles: Current status and future outlook,” Carbon Energy (2020), vol. 2, issue 1, page 6-43, which is also hereinafter referred to as a first academic reference, to serve as a reference for designing the method of the present disclosure. Referring to FIG. 1, a simulation diagram in the first academic reference is shown. The simulation diagram was obtained from S.-H. Joo et al., “Selective extraction and separation of nickel from cobalt, manganese and lithium in pre-treated leach liquors of ternary cathode material of spent lithium-ion batteries using synergism caused by Versatic 10 acid and LIX 84-I,” Hydrometallurgy (2016), vol. 159, pages 65-74, which is also hereinafter referred to as a second academic reference. In the second academic reference, a HSC Chemistry software was used to simulate and predict solubility of hydroxide of each of various types of metal ions at various pH values based on Equation (1) and Equation (2) shown below, and equilibrium constants of hydroxide materials at a normal temperature. The inventors of the present disclosure consulted simulation results shown in FIG. 1, and thus a precipitation sequence for precipitating various metal ions in the leachate solution in step a) of the method of the present disclosure was determined. That is, theoretically, when the pH value of the leachate solution is gradually increased, precipitates of the iron ions, the aluminum ions, and the copper ions may be sequentially precipitated.

$${M}^{n +} + {n H}_{2} O = {M ( OH )}_{n} + {n H}^{+} ( for n = 1 , 2 , and 3 ) \qquad ( 1 )$$

$$log \{ {C}_{M}^{n +} \} = - n pH + log K - log γ {M}^{n +} \qquad ( 2 )$$

By conducting experiments, the inventors found that the simulation results may indeed be used for removing impurities effectively in a series of steps (i.e., approaches in step b) and in step c)). Furthermore, the inventors inferred from FIG. 1 that nickel hydroxide, cobalt hydroxide, and manganese hydroxide may precipitate in a similar pH value range. Theoretically, it is challenging to respectively precipitate them in a series of steps. Thus, a co-precipitation process was designed and employed in step e). Based on experimental results, it was found that a particular combination involving one or more precipitation and separation processes in the method of the present disclosure may indeed show an outstanding separation performance.

Step b) involves adding the first pH adjusting agent into the leachate solution such that the pH value of the leachate solution is increased to the first target pH value, and the first metal precipitate is formed and separated from the leachate solution so as to obtain the first filtrate.

In some embodiments, the first pH adjusting agent includes sodium hydroxide, potassium hydroxide, ammonia, or combinations thereof. In certain embodiments, in step b), sodium hydroxide is used to serve as the first pH adjusting agent. In some embodiments, in step b), the first pH adjusting agent has a concentration ranging from 2 M to 15 M. In certain embodiments, the concentration ranges from 2 M to 10 M.

In some embodiments, in step b), the first target pH value ranges from 2 to 4. If the first target pH value is smaller than 2, the precipitation of the first metal may be incomplete. If the first target pH value is larger than 4, the first metal precipitate may include impurities (e.g., the aluminum ions, the copper ions, the zinc ions, etc.). In certain embodiments, in step b), the first target pH value is 3.

In some embodiments, step b) is performed at the room temperature or at an elevated temperature ranging from 40° C. to 50° C. In some embodiments, step b) is performed for a time period ranging from 0.5 hrs to 3 hrs. In certain embodiments, step b) is performed for the time period of 1 hr. In some embodiments, in step b), the first metal precipitate includes iron phosphate. In addition, after the first metal precipitate is filtered, the first filtrate in step b) includes the aluminum ions, the copper ions, the zinc ions, the nickel ions, the cobalt ions, the manganese ions, the lithium ions, or combinations thereof.

Step c) involves adding the second pH adjusting agent into the first filtrate such that the pH value of the first filtrate is increased to the second target pH value which is greater than the first target pH value, and the second metal precipitate is formed and separated from the first filtrate so as to obtain the second filtrate.

The second pH adjusting agent in step c) and the first pH adjusting agent in step b) may be the same as or different from each other.

In some embodiments, the second pH adjusting agent in step c) includes sodium hydroxide, potassium hydroxide, ammonia, or combinations thereof. In certain embodiments, sodium hydroxide may be used to serve as the second pH adjusting agent in step c). In some embodiments, the second pH adjusting agent in step c) has a concentration ranging from 2 M to 15 M. In certain embodiments, the concentration ranges from 2 M to 10 M.

In some embodiments, the second target pH value in step c) ranges from 4.5 to 6. If the second target pH value is smaller than 4.5, the precipitation of the second metal may be incomplete, such that the second filtrate may include residual impurity metal ions. If the second target pH value is larger than 6, the second metal precipitate may include precipitates of impurity metal ions (e.g., the nickel ions, the cobalt ions, etc.), such that there may be an undesired recovery rate in the second metal precipitate. In certain embodiments, in step c), the second target pH value is 6.

In some embodiments, step c) is performed at the room temperature or at an elevated temperature ranging from 40° C. to 50° C. In some embodiments, step c) is performed for a time period ranging from 1 hr to 5 hrs. In certain embodiments, step c) is performed for the time period of 1 hr. In some embodiments, the second metal precipitate in step c) includes aluminum hydroxide, copper hydroxide, zinc hydroxide, or combinations thereof. In addition, after the second metal precipitate is filtered, the second filtrate in step c) includes the nickel ions, the cobalt ions, the manganese ions, the lithium ions, or combinations thereof.

After step b) and step c), impurity metal elements, which are intended to be removed for preparing the precursor of the nickel-cobalt-manganese ternary cathode, are removed in a step-by-step manner through the aforesaid precipitation processes. However, the ratio of the nickel ions, the cobalt ions, and the manganese ions in the second filtrate obtained in step c), which can be determined by an inductively coupled plasma-optical emission spectroscopy (ICP-OES), may not be a ratio proper for preparing the precursor of the nickel-cobalt-manganese ternary cathode. Thus, the ratio of the nickel ions, the cobalt ions, and the manganese ions in the second filtrate should be adjusted in step d).

Step d) involves adding the concentration-adjusting agent into the second filtrate to adjust the ratio of the nickel ions, the cobalt ions, and the manganese ions in the second filtrate to the target ratio so as to obtain the mother liquid including the nickel ions, the cobalt ions, and the manganese ions with the target ratio.

In some embodiments, in step d), the concentration-adjusting agent includes sulfate salt, nitrate salt, or acetate salt of nickel, cobalt, manganese, or combinations thereof. In certain embodiments, in step d), the concentration-adjusting agent includes nickel sulfate, cobalt sulfate, manganese sulfate, or combinations thereof. In some embodiments, in step d), the target ratio is a mole ratio of the nickel ions, the cobalt ions, and the manganese ions, which is represented by x:y:z where x ranges from 1 to 10; y ranges from 1 to 4; and z ranges from 1 to 5. In certain embodiments, in step d), x is 1; y is 1; and z is 1. In certain embodiments, in step d), x is 6; y is 2; and z is 2. The aforesaid two ratios are mole ratios that are mainly used in commercialized nickel-cobalt-manganese ternary cathodes.

The method of the present disclosure may further include an ion concentration detection step, which is performed after step c) and prior to step d), and which is used to detect concentrations of the nickel ions, the cobalt ions, and the manganese ions in the second filtrate in step c). In addition, the ion concentration detection step may be accomplished using the ICP-OES. Based on results from the ICP-OES, variations between concentrations of the nickel ions, the cobalt ions, and the manganese ions in detection results and concentrations thereof in the target ratio may be estimated. Thus, a required amount of the concentration-adjusting agent (e.g., amounts of nickel sulfate, cobalt sulfate, and manganese sulfate) may be determined. In addition, in step d), subsequent to adding the concentration-adjusting agent, there may also be another ion concentration detection step so as to confirm that concentrations of the nickel ions, the cobalt ions, and the manganese ions in the mother liquid are suitable for the target ratio. The another ion concentration detection step may also be accomplished using the ICP-OES.

Step e) involves adding the co-precipitant into the mother liquid until the pH value of the mother liquid is increased to the third target pH value which is greater than the second target pH value, such that the nickel ions, the cobalt ions, and the manganese ion in the mother liquid are co-precipitated, so as to obtain the precursor of the nickel-cobalt-manganese-containing ternary cathode material.

In some embodiments, the co-precipitant in step e) includes sodium hydroxide, sodium hypochlorite, sodium carbonate, potassium hydroxide, potassium carbonate, ammonia, or combinations thereof. In some embodiments, a sodium hypochlorite solution is used and serves as the co-precipitant. In certain embodiments, in step e), sodium hydroxide is used to serve as the co-precipitant. In some embodiments, in step e), the co-precipitant has a concentration ranging from 2 M to 10 M. In some embodiments, in step e), the third target pH value ranges from 11 to 14. If the third target pH value is smaller than 11, the nickel ions may not completely precipitate, such that the precursor of the nickel-cobalt-manganese-containing ternary cathode may have an undesired composition ratio of nickel, cobalt, and manganese, thereby adversely affecting a recovery rate of the precursor. In some embodiments, in step e), the third target pH value ranges from 11.5 to 14.

In some embodiments, in step e), the co-precipitation process is performed at a co-precipitation temperature ranging from the room temperature to 80° C. In certain embodiments, the co-precipitation temperature is 60° C. In some embodiments, in step e), the co-precipitation process is performed for a time period ranging from 10 hrs to 24 hrs. In certain embodiments, in step e), the co-precipitation process is performed for the time period of 20 hrs.

In some embodiments, the precursor of the nickel-cobalt-manganese-containing ternary cathode obtained in step e) is a black powdery material. After the precursor is isolated, the ICP-OES may be further used to detect a composition ratio thereof so as to confirm purity of nickel-cobalt-manganese in the precursor. Generally, in order to make lithium-ion batteries manufactured in subsequent processes show superior electrochemical characteristics, the purity of nickel-cobalt-manganese in the precursor should not be less than 98 wt %. In some embodiments, the purity of nickel-cobalt-manganese in the precursor that is obtained from step e) is certainly not less than 98 wt %.

The method of the present disclosure may further include step f), which involves preparing the ternary cathode material using the precursor of the nickel-cobalt-manganese-containing ternary cathode, which is obtained from step e). Step f) may be employed by a well-known method. For example, in some embodiments, step f) involves subjecting the precursor of the nickel-cobalt-manganese-containing ternary cathode, which is isolated, to a ball milling process, followed by mixing the precursor with a lithium powdery material to form a mixture. Then, the mixture is subjected to a pellet-forming process to form pellets, followed by subjecting the pellets to a pre-sintering process and a sintering process in a furnace to obtain the ternary cathode material. In some embodiments, in step f), the pre-sintering process is performed at 500° C. for 5 hrs. In some embodiments, the sintering process is performed at 900° C. for 12 hrs.

The ternary cathode material prepared by the method of the present disclosure may be analyzed by instruments (e.g., an X-ray diffractometer (XRD), a scanning electron microscope (SEM), and an X-ray photoelectron spectroscopy (XPS), etc.) so as to confirm whether a crystalline structure, a microstructure, a surface element distribution, and an oxidation state distribution thereof meet standards for a commercialized ternary cathode material. In addition, the ternary cathode material may be further used to prepare new lithium-ion batteries. It may be subjected to tests (e.g., electrochemical characteristics tests, cyclic stability test, etc.) by instruments (e.g., a Neware Battery Tester, etc.) to confirm whether electrochemical performance thereof meets requirements for commercialization.

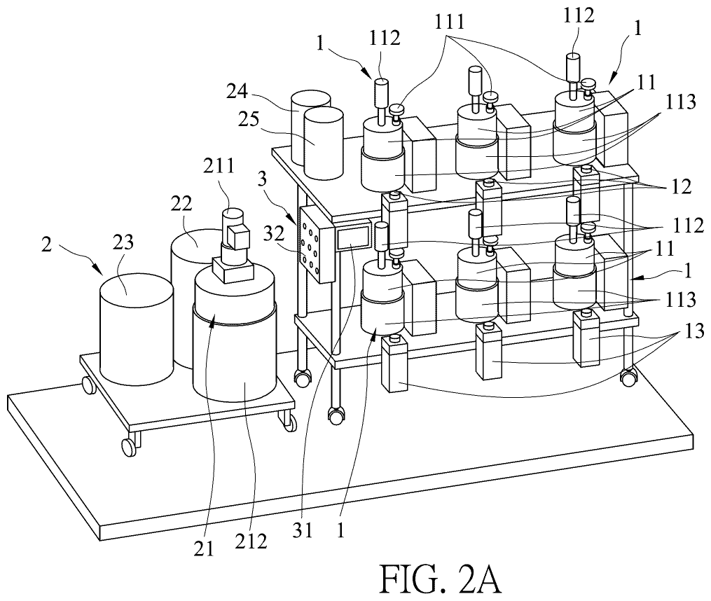

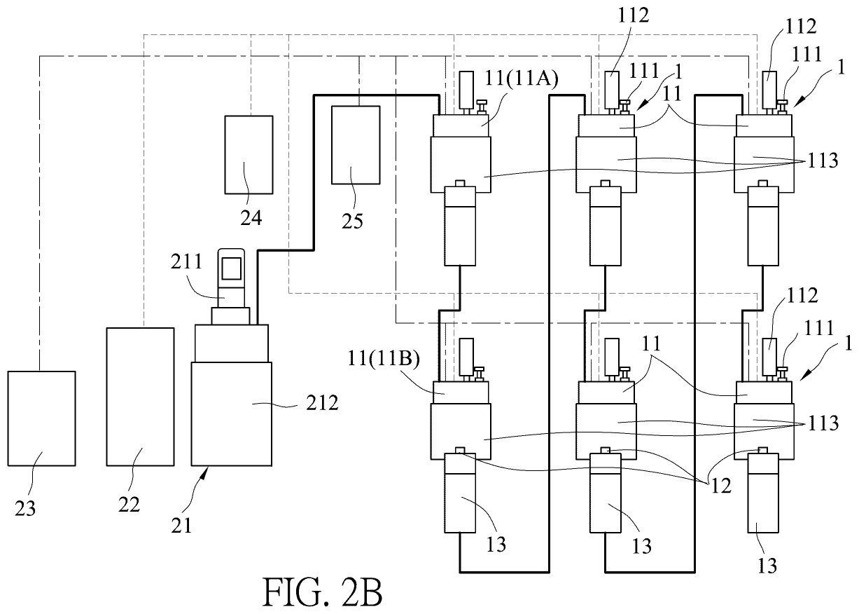

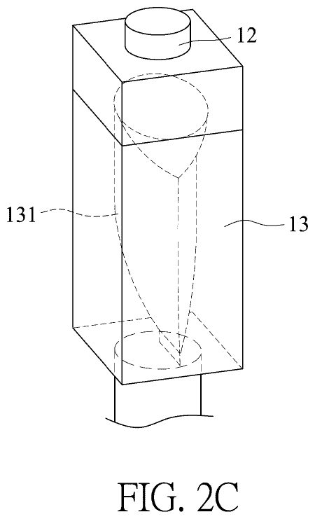

The method of present disclosure for preparing the ternary cathode material from the waste lithium-ion batteries may also cooperate with a customized automatic machine, so that the method may be performed automatically on a large scale. Referring to FIG. 2A and FIG. 2B, a perspective view and a schematic view of an automatic machine are respectively shown. The automatic machine includes a plurality of reaction units 1 that are in communication with one another through pipelines (represented by bold lines in FIG. 2B), a feeding unit 2 that is connected to the plurality of reaction units 1, and a control unit 3 that is in signal communication with the plurality of reaction units 1 and the feeding unit 2.

Each of the plurality of reaction units 1 includes a reaction tank 11, a solenoid valve 12 that is connected to a downstream side of the reaction tank 11, and a filtration box 13 that is located in a downstream side of the solenoid valve 12 (see FIG. 2C). A volume of the reaction tank 11 may be, for example, 10 liters, but is not limited thereto. The volume of the reaction tank 11 corresponds to, for example, 100 g of the cathode material of the waste lithium-ion batteries. The reaction tank 11 may be made of, for example, a Teflon-coated stainless steel material, but is not limited thereto. The reaction tank 11 includes a pH meter 111, a stirring module 112 and a temperature controlling module 113 that are in signal communication with the control unit 3. The stirring module 112 may include, for example, an electrically controlled stirring machine, but is not limited thereto. The temperature controlling module 113 may be, for example, an electrically controlled heating bag. The filtration box 13 includes a filtration bag 131 (see FIG. 2C) that is used to separate solid precipitates from solutions. A downstream side of the filtration box 13 is configured with a pipe (not shown) that is connected to the reaction tank 11 of a subsequent one of the plurality of reaction units 1, and a pump (not shown) that is in signal communication with the control unit 3.

The feeding unit 2 includes a leaching tank 21 that is used to execute the leaching process in step a), an acid storage tank 22 that is used to store an acid, a base storage tank 23 that is used to store a base, an acid feeding tank 24 that is connected to the acid storage tank 22 and that is used to feed the acid into the reaction tanks 11, and a base feeding tank 25 that is connected to the base storage tank 23 and that is used to feed the base into the reaction tanks 11. Each of the leaching tank 21, the acid storage tank 22, the base storage tank 23, the acid feeding tank 24, and the base feeding tank 25 may be made of, for example, polypropylene (PP), but is not limited thereto. Each of the leaching tank 21, the acid storage tank 22, the base storage tank 23, the acid feeding tank 24, and the base feeding tank 25 is configured with a pump (not shown) that is in signal communication with the control unit 3.

The leaching tank 21 further includes a stirring element 211 and a heating element 212, each of which is in signal communication with the control unit 3. The stirring element 211 may include, for example, an electrically controlled stirring machine, but is not limited thereto. The heating element 212 may include, for example, an electrically controlled heating bag, but is not limited thereto. The acid that is stored in the acid storage tank 22 may be, for example, sulfuric acid, but is not limited thereto. The base that is stored in the base storage tank 23 may be, for example, sodium hydroxide, but is not limited thereto. The acid in the acid storage tank 22 may firstly be pumped into the acid feeding tank 24, and then be separately pumped into the reaction tanks 11 through distribution pipelines (represented by dotted lines in FIG. 2B). The base in the base tank 23 may be firstly pumped into the base feeding tank 25, and then be separately pumped into the reaction tanks 11 through distribution pipelines (represented by chain lines in FIG. 2C). Through combining the acid feeding tank 24 and the base feeding tank 25, a pH value in each of the reaction tanks 11 may be controlled in real time.

The control unit 3 includes a display module 31 that is used to display parameters (e.g., a reaction temperature, a reaction time period, a pH value, etc.) in each of the reaction tanks 11, an input module (not shown) that is used for users to set target parameters, and a control module 32 that can control the feeding unit 2 to feed materials and that can control switches of the solenoid valves 12. The control module 32 may be, for example, a programmable logic controller (PLC), but is not limited thereto. The control module 32 may also be used to control the stirring module 112 and the temperature controlling module 113 of each of the reaction tanks 11, and the stirring element 211 and the heating element 212 of the leaching tank 21.

In some embodiments, in performing the method of the present disclosure to prepare the ternary cathode material from the waste lithium-ion batteries, the cathode materials of the waste lithium-ion batteries are placed in the leaching tank 21 for performing step a). First, suitable amounts of the acid and the reducing agent are manually added. The heating element 212 is switched on through the control module 32 to heat the leaching tank 21 to a target temperature. Meanwhile, the stirring element 211 is turned on to slowly stir for a target time period so as to uniformly mix the acid leachate with the cathode material of the waste lithium-ion batteries, thereby obtaining the leachate solution. Then, the feeding unit 2 is controlled through the control module 32, so as to pump a target volume of the leachate solution from the leaching tank 21 to a reaction tank 11A (see FIG. 2B).

Then, step b) is performed in the reaction tank 11A. A target temperature, a target pH value and a target reaction time period for the reaction tank 11A are set through the input module for the temperature control module 113 to be controlled through the control module 32 so as to heat the reaction tank 11A to the target temperature. In addition, the feeding unit 2 is simultaneously controlled to pump the base from the base feeding tank 25 to the reaction tank 11A, where the base is used to serve as the first pH adjusting agent, thereby increasing a pH value of the leachate solution in the reaction tank 11A.

The pH meter 111 controlled by the control module 32 may be used to check if the pH value of the leachate solution in the reaction tank 11A reaches the target pH value. If the pH value doesn't reach the target pH value, the feeding unit 2 is then controlled to continuously pump the base to the reaction tank 11A until the pH value of the leachate solution reaches the target pH value. When the base is pumped into the reaction tank 11A, the stirring module 112 is turned on by the control module 32 to stir the leachate solution in the reaction tank 11A. When a feeding process on the reaction tank 11A is terminated, the stirring module 112 is controlled to keep stirring for the target reaction time period so as to accomplish a precipitation reaction for the first metal precipitate in the leachate solution, thereby obtaining the first filtrate. Then, the solenoid valve 12 is enabled to allow the first filtrate to flow through the filtration bag 131 of the filtration box 13, and thus the first metal precipitate is filtered. Thereafter, the first filtrate may flow into a reaction tank 11B through the pipe. If the pH value of the leachate solution in the reaction tank 11A is larger than the target pH value, where it can be detected by the pH meter 111 controlled by the control module 32, the feeding unit 2 is then controlled to pump a proper amount of the acid into the reaction tank 11A from the acid feeding tank 24. The pH value of the leachate solution in the reaction tank 11A is continuously monitored. A feeding process on the reaction tank 11A is terminated when the pH value of the leachate solution returns to the target pH value.

After the first filtrate flows into the reaction tank 11B, step c) may be subsequently performed. Since the procedures for performing step c) and step e) by the automatic machine are similar to those for performing step b), and the procedures for performing step d) by the automatic machine are similar to those for performing step a), details thereof are omitted for the sake of brevity. The feeding unit 2 of the automatic machine may further be configured with storage tanks for the acid leachate and the concentration-adjusting agent, so that feeding processes in step a) and step d) may also be performed automatically. It should be noted that, in performing step d), users may not know in advance a target volume of the concentration-adjusting agent that is required to be fed. Thus, a detection machine for detecting an element composition, which can be internally configured in the automatic machine, is required to be established in the automatic machine. Thus, when the automatic machine is operating, the detection machine may provide feedback to the control module 32 so that the target volume of the concentration-adjusting agent that is required in step d) can be calculated. In addition, a process for setting various target parameters by the input module may not necessarily be performed prior to each of the steps. Basically, they can be set once at an initial stage in performing the method.

In addition to the detailed descriptions above, the following descriptions further provide example(s) of the method for preparing ternary cathode material from the recycled waste lithium-ion batteries of the present disclosure.

### Example 1

100 kg of a cathode powdery material of lithium-nickel-cobalt-manganese oxides-containing waste lithium-ion batteries (i.e., the cathode material of the waste lithium-ion batteries) was obtained from Chung Tai™ Resource Technology Corporation. A pretreatment process for the cathode material of the waste lithium-ion batteries included soaking the waste lithium-ion batteries in a sodium chloride solution so as to make the waste lithium-ion batteries be completely discharged. Then, binders were gasified in an oxygen-enriched furnace at an elevated temperature (e.g., at a temperature from 500° C. to 600° C.), so that the cathode material and current collectors may be separated from each other. The cathode material separated from the current collectors were mechanically crushed to obtain the cathode material of the waste lithium-ion batteries. Then, the ICP-OES was used to detect a composition of the cathode material of the waste lithium-ion batteries, and details of the composition of the cathode material of the waste lithium-ion batteries are shown in row (A) of Table 1. The cathode material of the waste lithium-ion batteries was placed into a reaction tank. Then, 2M sulfuric acid was gradually added therein, followed by adding 2 wt % of a hydrogen peroxide solution. The reaction tank was heated to 65° C. to conduct a reaction for 1 hr with stirring, thereby obtaining a leachate solution including iron ions, phosphorous ions, aluminum ions, copper ions, zinc ions, nickel ions, cobalt ions, manganese ions and lithium ions.

TABLE 1

| wt % | Iron | Aluminum | Copper | Zinc | Nickel | Cobalt | Manganese | Lithium |
|---|---|---|---|---|---|---|---|---|
| (A) | 3.28 | 2.03 | 1.99 | 17.48 | 16.41 | 17.82 | 33.71 | 7.27 |
| (B) | 0.01 | 0 | 2.63 | 6.32 | 15.84 | 28.74 | 31.36 | 15.08 |
| (C) | 0.01 | 0 | 1.64 | 5.38 | 28.49 | 26.44 | 28.34 | 9.69 |
| (D) | 0.03 | 0 | 0.71 | 1.19 | 33.74 | 31.90 | 32.38 | 0 |

A 2M sodium hydroxide solution was gradually added into the leachate solution at a room temperature so that a pH value of the leachate solution was increased to 3 (the pH value of the leachate solution can be detected by a pH meter). The aforesaid process was performed for 1 hr with stirring so as to precipitate iron phosphate. A Iron phosphate precipitate was filtered to obtain a first filtrate including the aluminum ions, the copper ions, the zinc ions, the nickel ions, the cobalt ions, the manganese ions, and the lithium ions.

At the room temperature, the 2M sodium hydroxide was gradually added into the first filtrate to increase a pH value of the first filtrate to 6. The aforesaid process was performed for 1 hr with stirring so as to completely precipitate aluminum hydroxide, copper hydroxide, and zinc hydroxide. Precipitates of aluminum hydroxide, copper hydroxide, and zinc hydroxide were filtered to obtain a second filtrate including the nickel ions, the cobalt ions, the manganese ions, and the lithium ions.

A composition of the second filtrate was detected by the ICP-OES, and results are shown in row (B) of Table 1. As shown in row (B) of Table 1, a weight percentage ratio of nickel, cobalt, and manganese elements in the second filtrate respectively is about 16:29:31. Since atomic masses of nickel, cobalt, and manganese (i.e., nickel: 58.69, cobalt: 58.93, manganese: 54.94) are similar to each other, a mole ratio thereof may be approximated by using a weight percentage ratio thereof. On the premise that the target ratio thereof is 1:1:1, it could be understood that a larger amount of nickel sulfate and a smaller amount of cobalt sulfate were required to be added into the second filtrate while manganese sulfate may not be required. Thus, a mother liquid including the nickel ions, the cobalt ions, and the manganese ions with a ratio of 1:1:1 was obtained.

A composition of the mother liquid was detected by the ICP-OES, and the results are shown in row (C) of Table 1. It is revealed that a ratio of the nickel ions, the cobalt ions, and the manganese ions is about the mole ratio of 1:1:1.

The mother liquid was heated to 60° C., and then the 2M sodium hydroxide solution was gradually added so as to increase a pH value of the mother liquid to 11.5. The aforesaid process was performed for 20 hrs with stirring, so as to completely precipitate a mixture of nickel hydroxide, cobalt hydroxide, and manganese hydroxide (i.e., a precursor of a nickel-cobalt-manganese ternary cathode).

After a separation process, the precursor of the nickel-cobalt-manganese ternary cathode with a weight of 14.3 g was obtained. Then, the ICP-OES was used to detect a composition thereof, and results are shown in row (D) of Table 1. It is revealed that purity of the precursor of the nickel-cobalt-manganese ternary cathode reaches 98.02 (i.e., a sum of 33.74+31.90+32.38), suggesting that the precursor is a high-purity precursor. The precursor of the nickel-cobalt-manganese ternary cathode was subjected to the ball milling process in a machine, and 5.78 g of a lithium powdery material was added and mixed uniformly. Then, the precursor was subjected to the pellet-forming process in a pressing machine to form pellets. The pellets were placed in a high temperature furnace at 500° C. for the pre-sintering process for 5 hrs. Thereafter, the high temperature furnace was heated to 900° C. so as to conduct the sintering process on the precursor of the nickel-cobalt-manganese ternary cathode for 12 hrs to obtain a ternary cathode material, which was sintered.

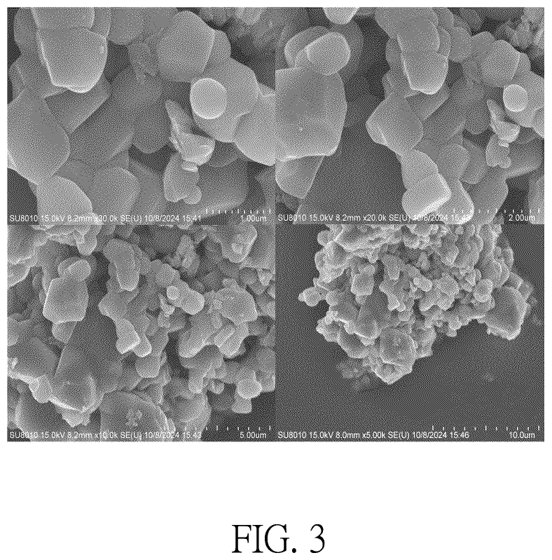

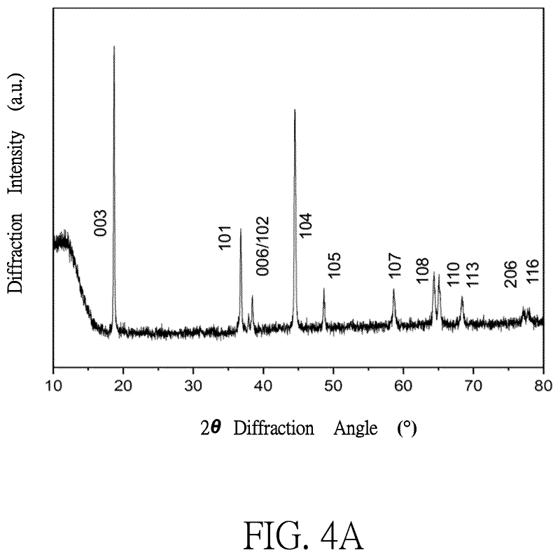

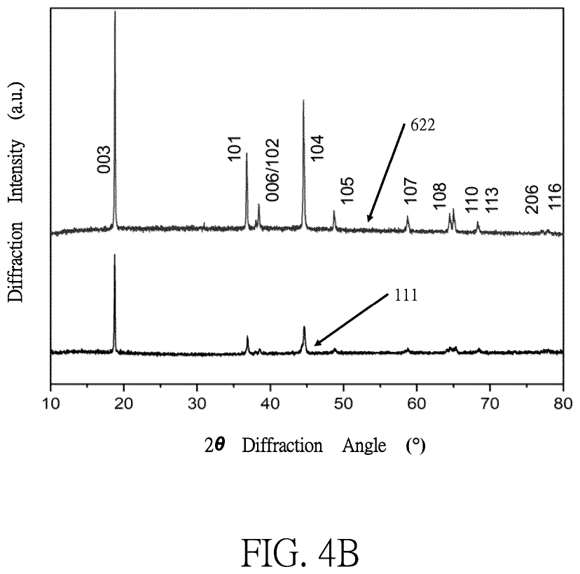

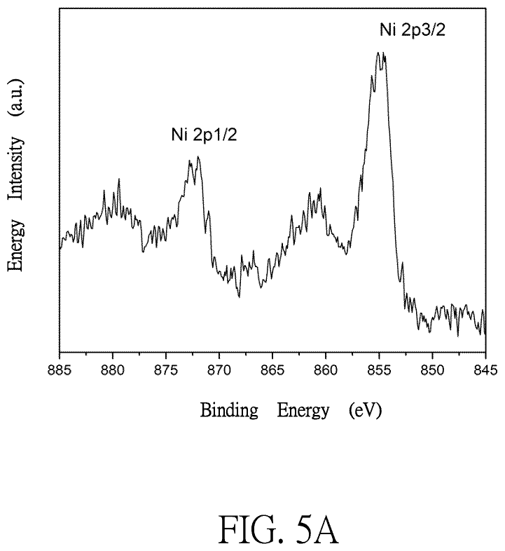

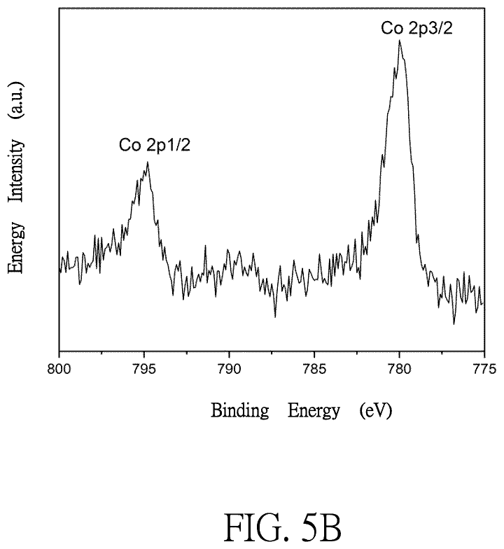

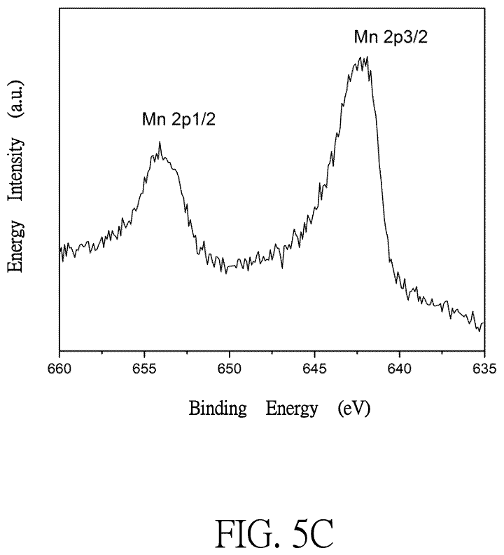

The ternary cathode material was subsequently analyzed by the SEM, the XRD, and the XPS so as to obtain microscopic images (see FIG. 3) and analytical data (see FIGS. 4A, 4B, and FIGS. 5A to 5C). Referring to FIG. 3, SEM images of the ternary cathode material at various magnifications are shown. As shown in FIG. 3, a microscopic surface structure of the ternary cathode material is composed of smooth particles, which are non-spherical and polyhedral. In addition, primary particles have a size ranging from 0.5 μm to 1 μm. The primary particles may aggregate together to form secondary particles that have a size greater than 10 μm. In addition, analytical results for the ternary cathode material, obtained by a scanning electron microscope-energy dispersive spectroscopy (SEM-EDS), show that the nickel, cobalt, and manganese elements are evenly distributed over surfaces of non-spherical particles. The analytical results for the element composition obtained from the SEM-EDS are shown in Table 2. They show that purity of nickel-cobalt-manganese in the ternary cathode material reaches 94.58 atomic percent (at. %). In addition, a ratio of the manganese, cobalt, and manganese elements is 1:1:1, indicating that the co-precipitation process in step e) is relatively complete. They also suggest that the ball milling process, the pre-sintering process, and the sintering process performed after the co-precipitation process may not further change the ratio of the manganese, cobalt, and manganese elements in the ternary cathode material.

TABLE 2
Composition detected by SEM-EDS (at. %)

| Nickel | Cobalt | Manganese |
|---|---|---|
| 31.68 | 31.86 | 31.04 |

Referring to FIG. 4A, an X-ray diffraction spectrum of the ternary cathode material is shown. A diffraction pattern shown in FIG. 4A indicates that the ternary cathode material is formed with a hexagonal α-NaFeO₂ type crystal structure, which belongs to a R3̅m space group. In addition, diffraction peaks are distinct and background of the diffraction pattern is clear, indicating that the ternary cathode material has a good crystallinity and a high-purity. Moreover, particular split peaks in (006)/(102) and (108)/(110) suggest that the ternary cathode material has a layered structure that is well-ordered, which facilitates an intercalation and de-intercalation for lithium ions. Referring to FIG. 4B, XRD diffraction spectra of two commercialized ternary cathode materials are shown. By comparing FIG. 4A and FIG. 4B, it can be found that positions of the diffraction peaks in the XRD spectrum of the ternary cathode material of the present embodiment are consistent with positions of diffraction peaks in the XRD spectra of the two commercialized ternary cathode materials.

FIGS. 5A, 5B, and 5C are XPS spectra of nickel, cobalt, and manganese in the ternary cathode material, respectively. FIG. 5A shows that a binding energy peak value of nickel is at about 854 eV, and that an oxidation state of nickel includes an oxidation state of +2. FIG. 5B shows that a binding energy peak value of cobalt is at about 779 eV, and that an oxidation state of cobalt includes an oxidation state of +3. FIG. 5C shows that a binding energy peak value of manganese is at about 643 eV, and that an oxidation state of manganese includes an oxidation state of +4. These results are consistent with literatures that typically describe the nickel-cobalt-manganese ternary cathode material. Examples of the literatures include (1) X. Zhang et al., “A novel process for recycling and resynthesizing LiNi_{1/3}Co_{1/3}Mn_{1/3}O₂ from the cathode scraps intended for lithium-ion batteries,” Waste management (2014), vol. 34, pages 1715-1724; (2) T. H. Cho et al., “Effect of synthesis condition on the structural and electrochemical properties of Li [Ni_{1/3}Mn_{1/3}Co_{1/3}]O₂ prepared by carbonate co-precipitation method,” Journal of power sources (2005), vol. 142, pages 306-312; and (3) S. Gopukumar et al., “Novel synthesis of layered LiNi_{1/2}Mn_{1/2}O₂ as cathode material for lithium rechargeable cells,” Electrochimica Acta (2004), vol. 49, pages 803-810, but are not limited thereto. Manganese ions, which have the oxidation state of +4, have a lower electrochemical activity. Nickel ions having the oxidation state of +2 and cobalt ions having the oxidation of +3 have larger electrochemical activities. Thus, during a charging and discharging process, the manganese ions having the oxidation state of +4 may function to maintain structural stability; the nickel ions having the oxidation state of +2 and the cobalt ions having the oxidation state of +3 may function to maintain electrical equilibrium.

After the ternary cathode material was confirmed to satisfy application requirements, the ternary cathode material was further processed to be manufactured into a lithium-ion battery that is new. The lithium-ion battery was then subjected to the tests for the electrochemical characteristics and the cyclic stability by the Neware Battery Tester. A process for manufacturing the lithium-ion battery from the ternary cathode material is well-known, and can be implemented in various ways of implementation. The following description illustrates only one of the ways of implementation. A bottom case is placed with an opening thereof facing up, and a coated and cut cathode material is placed therein. A separation membrane is then placed therein, followed by dripping in an electrolyte. Then, a lithium metal is placed thereon, and is packaged with a spacer, a spring washer, and an upper cap. After pressing the bottom case and the upper cap, the lithium-ion battery is obtained.

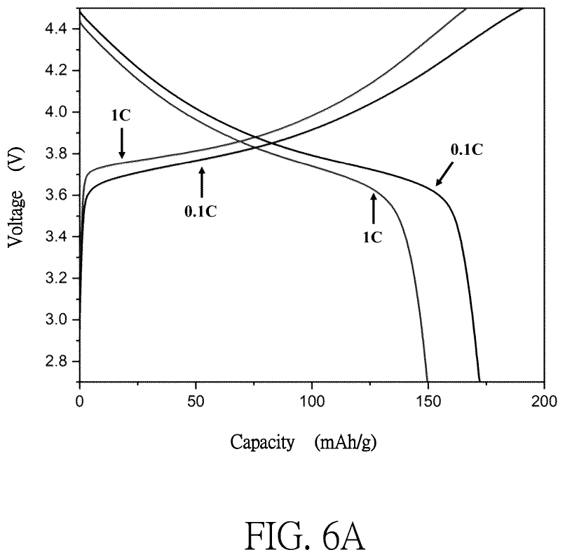

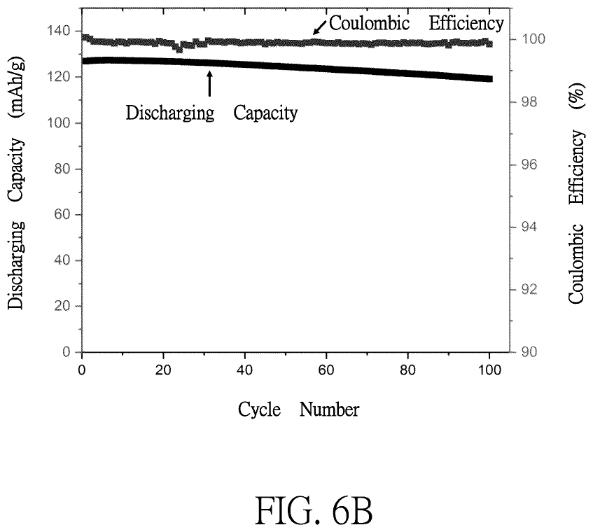

Referring to FIG. 6A, an initial charging-discharging chart of the lithium-ion battery is shown. Current densities in tests were respectively maintained at 0.1 C (i.e., 16 mA/g, or a charging time period of 10 hrs), and at 1 C (i.e., 160 mA/g, or a charging time period of 1 hr). In the tests, voltages each ranged from 2.7 V to 4.5 V, which is a typical voltage test range. If a voltage test range is excessively broad, the lithium-ion battery may be over-charged or over-discharged and may cause stability issues. A battery made from the ternary cathode material prepared in the embodiment showed a plateau of charging-discharging at about 3.75 V, whether on a curve of 0.1 C or on a curve of 1 C. The plateau is a characteristic of the nickel-cobalt-manganese ternary cathode material. The battery showed an initial discharging capacity of 173.9 mAh/g and an initial Coulombic efficiency of about 87% on the curve of 0.1 C. The battery showed an initial discharging capacity of 151.2 mAh/g and an initial Coulombic efficiency of about 92% on the curve of 1 C. It is suggested that the battery can meet commercial standards and exhibit good performance.

Referring to FIG. 6B, a cyclic stability diagram of the lithium-ion battery is shown, and includes a curve for a discharging capacity of 0.5 C and a curve for a Coulombic efficiency curve of 0.5 C, each of which provides data that may be varied based on a cyclic number of a charging and discharging process. A current density of 0.5 C is a moderate rate of the charging-discharging process. As shown in FIG. 6B, after 100 cycles of the charging-discharging process, the discharging capacity may still remain at 93.02% of an initial discharging capacity. In addition, in the 100 cycles of the charging-discharging process, the Coulombic efficiency may basically remain at a high-efficiency close to 100%. It is suggested that it can meet the commercial standards and exhibit outstanding performance.

In summary, the method of preparing the ternary cathode material from the waste lithium-ion batteries may be suitable for the all types of the waste lithium-ion batteries where various cathode materials of the waste lithium-ion batteries may be processed at the same time. In addition, through stepwise precipitation processes to increase the pH value step-by-step, impurities of various metal ions may be gradually removed. Finally, a high-purity precursor of a ternary cathode may be produced. It may be used for manufacturing the lithium-ion battery with outstanding electrochemical performance. Furthermore, each of the steps in the present disclosure is performed in an aqueous phase, and thus organic wastes may not be produced. As such, the difficulty in treating waste liquids may be reduced, suggesting that the method of the present disclosure is environmentally-friendly, and thus an object of the present disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIG., or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of preparing a ternary cathode material from waste lithium-ion batteries, comprising the steps of:
a) mixing a cathode material of the waste lithium-ion batteries with an acid leachate such that metal ions are leached from the cathode material so as to obtain a leachate solution including the metal ions;
b) adding a first pH adjusting agent into the leachate solution such that a pH value of the leachate solution is increased to a first target pH value, and a first metal precipitate is formed and separated from the leachate solution so as to obtain a first filtrate;
c) adding a second pH adjusting agent into the first filtrate such that a pH value of the first filtrate is increased to a second target pH value which is greater than the first target pH value, and a second metal precipitate is formed and separated from the first filtrate so as to obtain a second filtrate;
d) adding a concentration-adjusting agent into the second filtrate to adjust a ratio of nickel ions, cobalt ions, and manganese ions in the second filtrate to a target ratio so as to obtain a mother liquid including the nickel ions, the cobalt ions, and the manganese ions with the target ratio; and
e) adding a co-precipitant into the mother liquid until a pH value of the mother liquid is increased to a third target pH value which is greater than the second target pH value, such that the nickel ions, the cobalt ions, and the manganese ion in the mother liquid are co-precipitated, so as to obtain a precursor of a nickel-cobalt-manganese-containing ternary cathode material.

2. The method as claimed in claim 1, further comprising, prior to step a): providing the cathode material of the waste lithium-ion batteries, wherein the cathode material includes a cathode material of waste lithium cobalt oxide batteries, a cathode material of waste lithium manganese oxide batteries, a cathode material of waste lithium nickel cobalt manganese oxide batteries, a cathode material of waste lithium nickel cobalt aluminum oxide batteries, a cathode material of waste lithium iron phosphate batteries, or combinations thereof.

3. The method as claimed in claim 1, wherein in step a), the acid leachate includes an acid.

4. The method as claimed in claim 3, wherein the acid includes hydrochloric acid, nitric acid, sulfuric acid, phosphoric acid, acetic acid, citric acid, L-tartaric acid, or combinations thereof.

5. The method as claimed in claim 1, wherein in step a), the metal ions include iron ions, phosphorous ions, aluminum ions, copper ions, zinc ions, nickel ions, cobalt ions, manganese ions, lithium ions, or combinations thereof.

6. The method as claimed in claim 1, wherein the first pH adjusting agent and the second pH adjusting agent are the same as or different from each other, and each independently includes sodium hydroxide, potassium hydroxide, ammonia, or combinations thereof.

7. The method as claimed in claim 1, wherein in step b), the first target pH value ranges from 2 to 4.

8. The method as claimed in claim 1, wherein in step b), the first metal precipitate includes iron phosphate.

9. The method as claimed in claim 1, wherein in step b), the first filtrate includes aluminum ions, copper ions, zinc ions, nickel ions, cobalt ions, manganese ions, lithium ions, or combinations thereof.

10. The method as claimed in claim 1, wherein in step c), the second target pH value ranges from 4.5 to 6.

11. The method as claimed in claim 1, wherein in step c), the second metal precipitate includes aluminum hydroxide, copper hydroxide, zinc hydroxide, or combinations thereof.

12. The method as claimed in claim 1, wherein in the step c), the second filtrate includes nickel ions, cobalt ions, manganese ions, lithium ions, or combinations thereof.

13. The method as claimed in claim 1, wherein in step d), the concentration-adjusting agent includes sulfate, nitrate, or acetate of nickel, cobalt, manganese, or combinations thereof.

14. The method as claimed in claim 13, wherein in step d), the concentration-adjusting agent includes nickel sulfate, cobalt sulfate, manganese sulfate, or combinations thereof.

15. The method as claimed in claim 1, wherein in step d), the target ratio is a mole ratio of the nickel ions, the cobalt ions, and the manganese ions, which is represented by x:y:z, wherein x ranges from 1 to 10, y ranges from 1 to 5, and z ranges from 1 to 5.

16. The method as claimed in claim 15, wherein x is 1, y is 1, and z is 1.

17. The method as claimed in claim 1, wherein in step e), the co-precipitant includes sodium hydroxide, sodium hypochlorite, sodium carbonate, potassium hydroxide, potassium carbonate, ammonia, or combinations thereof.

18. The method as claimed in claim 1, wherein in step e), the third target pH value ranges from 11 to 14.

19. The method as claimed in claim 1, further comprising, after step e):
isolating the precursor;
subjecting the precursor to a ball-mill process;
mixing the precursor with a lithium powdery material to form a mixture;
subjecting the mixture to a pellet-forming process to form a pellet; and
subjecting the pellet to a pre-sintering process and a sintering process in a furnace to obtain the ternary cathode material.
